(19) United States
(12) Patent Application Publication
(10) Pub. No.: US 2021/0294498 A1
(43) Pub. Date: Sep. 23, 2021

(54) IDENTIFYING A BACKUP CLUSTER FOR DATA BACKUP

(71) Applicant: Hewlett Packard Enterprise Development LP, Houston, TX (US)

(72) Inventors: Taranisen Mohanta, Bangalore Karnataka (IN); Abhijith Umesh, Bangalore Karnataka (IN); Sidharth Malakangoud Patil, Bangalore Karnataka (IN); Leena Kotrabasappa Muddi, Bangalore Karnataka (IN); Anand Shankar Cherugunnu, Bangalore Karnataka (IN)

(21) Appl. No.: 17/249,806

(22) Filed: Mar. 15, 2021

(30) Foreign Application Priority Data
Mar. 19, 2020 (IN) 202041012000

(51) Int. Cl. G06F 3/06

(52) U.S. Cl. CPC G06F 3/065; G06F 9/45558; G06F 3/067; G06F 3/0619

(57) ABSTRACT

Some examples described herein relate to identifying a backup cluster for data backup. In an example, a primary source node may provide hash values of data on the primary source node to a plurality of cluster management systems, wherein each cluster management system manages a respective cluster. In response, the primary source node may receive mapping information of nodes in the respective cluster from corresponding cluster management system. The mapping information of a given node may indicate an extent of a match between the hash values of data on the source node and hash values of data on the given node. Based on mapping information of nodes, the primary source node may identify a backup cluster for backing up data on the primary source node.

### BACKGROUND

Cluster computing evolved as a means of doing parallel computing. A motivation for cluster computing was the desire to link multiple computing resources, which were underutilized, for parallel processing. Computer clusters may be configured for different purposes, for example, high-availability and load balancing.

### BRIEF DESCRIPTION OF THE DRAWINGS

For a better understanding of the solution, examples will now be described, with reference to the accompanying drawings, in which:

FIG. 1 illustrates an example cluster computer system;

FIG. 2 illustrates an example system for identifying a backup cluster for data backup;

FIG. 3 illustrates an example method of identifying a backup cluster for data backup;

FIG. 4 illustrates an example method of identifying a backup cluster for data backup; and

FIG. 5 is a block diagram of an example system including instructions in a machine-readable storage medium for identifying a backup cluster for data backup.

### DETAILED DESCRIPTION OF THE INVENTION

A distributed storage system is a computer network where information is stored on more than one node, often in a replicated fashion. In a distributed storage system, data may be stored on a multitude of nodes (e.g., servers), which behave as one storage system. A distributed storage system may include multiple clusters, with each cluster including one or more nodes.

A “cluster computer system” (also “computer cluster” or “cluster”) may be defined as a group of computing systems (for example, servers) and other resources (for example, storage, network, etc.) that act like a single system. A computer cluster may be considered as a type of parallel or distributed processing system, which may consist of a collection of interconnected computer systems cooperatively working together as a single integrated resource. In other words, a cluster is a single logical unit consisting of multiple computers that may be linked through a high speed network. A computing system in a cluster may be referred to as a “node”. In an example, each node in a cluster may run its own instance of an operating system. Clusters may be deployed to improve performance and availability since they basically act as a single, powerful machine. They may provide faster processing, increased storage capacity, and better reliability.

In a distributed storage system, data protection (e.g., backup and restore) is one of the desirable features to provide as part of data retention process for end users. In a typical remote backup, data of a Virtual Machine (VM) or a snapshot may be replicated to a target node in a remote data center. A user may specify a backup cluster for backing up data of a source node. This may result in inefficiency since the selection of a backup node may be based on a user's (e.g., a storage administrator) knowledge. A user may not be able to identify a cluster (e.g., in a datacenter) that is able to backup data in an efficient manner by using data management features such as deduplication. Further, performing a complete back up across a cluster may have inefficiencies. Transmitting an entire data set to a backup cluster increases Wide Area Network (WAN) traffic, and copying data over a long distance on WAN may be expensive. Thus, it may be desirable to perform a data backup to remote cluster by minimizing network traffic.

To address these technical challenges, the present disclosure describes various examples for identifying a backup cluster for data backup. In an example, a primary source node may provide hash values of data on the primary source node to a plurality of cluster management systems, wherein each cluster management system manages a respective cluster. In response, the primary source node may receive mapping information of nodes in the respective cluster from corresponding cluster management system. The mapping information of a given node may indicate an extent of a match between the hash values of data on the source node and hash values of data on the given node. Based on the mapping information of nodes, the primary source node may identify a backup cluster to serve as a destination for backing up data on the primary source node.

Examples described herein provide a solution for identifying best nodes across multiple clusters for carrying out data backup, by taking advantage of data deduplication feature. The proposed solution may help reduce WAN traffic, increase storage space efficiency by making use of data deduplication feature, and reduce data backup or restore time.

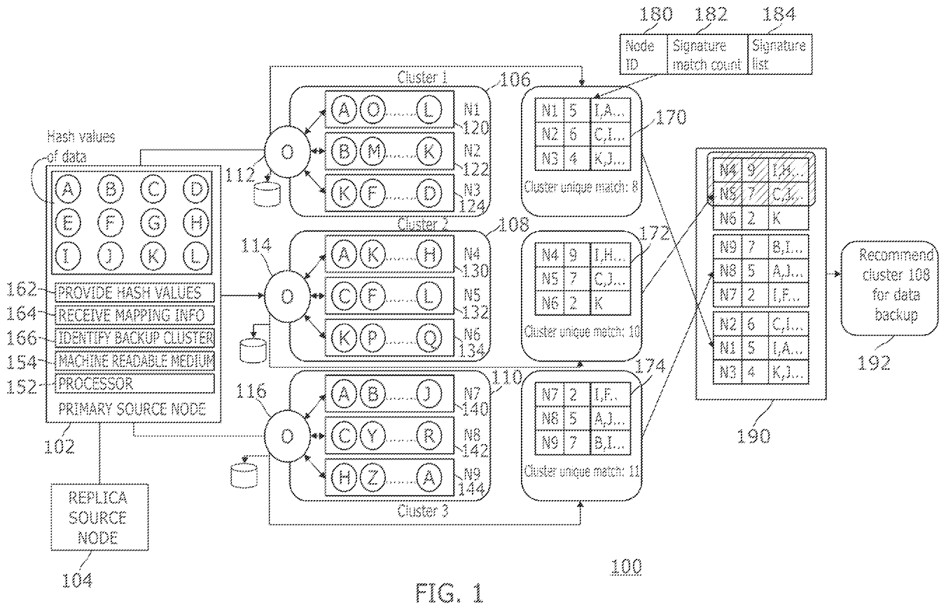

FIG. 1 illustrates an example distributed storage system 100. Distributed storage system 100 may include a primary source node 102, a replica source node 104, and clusters 106, 108, and 110. In an example, replica source node 104 may be a high availability (HA) pair of primary source node 102. In an example, replica source node 104 may include a copy of data present on primary source node 102. Each of the clusters 106, 108, and 110 may be managed by a respective cluster management system i.e. 112, 114, and 116 respectively. Further each of the clusters 106, 108, and 110 may include one or more nodes. For example, cluster 106 may include nodes N1 120, N2 122, and N3 124; cluster 108 may include nodes N4 130, N5 132, and N6 134; and cluster 110 may include nodes N7 140, N8 142, and N9 144. Although three clusters are shown in FIG. 1, other examples of this disclosure may include fewer or more than three clusters. Similarly, although three nodes are shown as part of each cluster in FIG. 1, other examples of this disclosure may include fewer or more than three nodes in a cluster.

As used herein, the term “node” may refer to any type of computing device capable of reading machine-executable instructions. Examples of the computing device may include, without limitation, a server, a desktop computer, a notebook computer, a tablet computer, and the like. Thus, in an example, primary source node 102, replica source node 104, nodes 120, 122, 124, 130, 132, 134, 140, 142, and 144 may each be a compute node comprising a processor.

In an example, nodes 120, 122, 124, 130, 132, 134, 140, 142, and 144 may each be a storage node. The storage node may include a storage device. The storage device may be an internal storage device, an external storage device, or a network attached storage device. Some non-limiting examples of the storage device may include a hard disk drive, a storage disc (for example, a CD-ROM, a DVD, etc.), a storage tape, a solid state drive (SSD), a USB drive, a Serial Advanced Technology Attachment (SATA) disk drive, a Fibre Channel (FC) disk drive, a Small Computer System Interface (SCSI) disk drive, a Serial Attached SCSI (SAS) disk drive, a magnetic tape drive, an optical jukebox, and the like. In an example, the storage device may be a Direct Attached Storage (DAS) device, a Network Attached Storage (NAS) device, a Redundant Array of Inexpensive Disks (RAID), a data archival storage system, or a block-based device over a storage area network (SAN). In another example, the storage device may be a storage array, which may include a storage drive or plurality of storage drives (for example, hard disk drives, solid state drives, etc.). In another example, the storage device may be a disk array or a small to medium sized server re-purposed as a storage system with similar functionality to a disk array having additional processing capacity. In an example, nodes 120, 122, 124, 130, 132, 134, 140, 142, and 144 may each be a part of a datacenter.

Cluster management systems 112, 114, and 116 may each be any type of computing device capable of reading machine-executable instructions. Examples of the computing device may include, without limitation, a server, a desktop computer, a notebook computer, a tablet computer, and the like.

In an example, primary source node 102, replica storage node 104, cluster management systems 112, 114, 116, clusters 106, 108, and 110 along with their respective nodes may be communicatively coupled via a computer network. The computer network may be a wireless or wired network. The computer network may include, for example, a Local Area Network (LAN), a Wide Area Network (WAN), a Wireless Local Area Network (WLAN), a Metropolitan Area Network (MAN), a Storage Area Network (SAN), a Campus Area Network (CAN), or the like. Further, the computer network may be a public network (for example, the Internet) or a private network (for example, an intranet).

In an example, primary source node 102 may include a processor 152 and a machine-readable storage medium 154 communicatively coupled through a system bus. Processor 152 may be any type of Central Processing Unit (CPU), microprocessor, or processing logic that interprets and executes machine-readable instructions stored in machine-readable storage medium 154. Machine-readable storage medium 154 may be a random access memory (RAM) or another type of dynamic storage device that may store information and machine-readable instructions that may be executed by processor 152. For example, machine-readable storage medium 154 may be Synchronous DRAM (SDRAM), Double Data Rate (DDR), Rambus DRAM (RDRAM), Rambus RAM, etc. or storage memory media such as a floppy disk, a hard disk, a CD-ROM, a DVD, a pen drive, and the like. In an example, machine-readable storage medium 154 may be a non-transitory machine-readable medium.

In an example, machine-readable storage medium 154 may store machine-readable instructions (i.e. program code) 162, 164, and 166 that, when executed by processor 152, may at least partially implement some or all functions of primary source node.

In an example, primary source node 102 may include instruction 162 to provide hash values of data on the primary source node to a plurality of cluster management systems, for example, 112, 114, and 116. In an example, data on primary source node 102 may include data of a Virtual Machine (VM) on primary source node 102. In an example, data on the primary source node 102 may be hashed using a cryptographic hash function (for example, Secure Hash Algorithm 1 (SHA-1) or Secure Hash Algorithm 2 (SHA-2)) which may take a data input and produce a hash value of data. In an example, data of a VM on the primary source node 102 may be hashed using, for example, an aforementioned cryptographic hash function, to generate hash values of VM data. The hash values may be provided to a plurality of cluster management systems, for example, 112, 114, and 116. In an example, each of the cluster management systems (112, 114, and 116) may manage a respective cluster, for example, 106, 108, and 110, respectively.

In an example, primary source node 102 may include instructions 164 to receive mapping information of nodes in an individual cluster (for example, 106, 108, and 110) from its corresponding cluster management system (e.g., 112, 114, and 116, respectively). In an example, mapping information of a given node may indicate an extent of a match between hash values of data on primary source node 102 and hash values of data on the given node.

In an example, in response to receiving hash values of data (e.g., related to a VM) from primary source node 102, each of the cluster management systems may forward hash values of data to nodes present in their respective cluster(s), for determining mapping information of each node. For example, referring to FIG. 1, cluster management system 112 may forward hash values of data (e.g., A, B, C, D, etc.) to nodes 120, 122, and 124 in cluster 106; cluster management system 114 may forward hash values of data to nodes 130, 132, and 134 in cluster 108; and cluster management system 116 may forward hash values of data to nodes 140, 142, and 144 in cluster 110.

In an example, mapping information of a given node may be determined by comparing hash values of data on primary source node 102 with hash values of data on the given node. The mapping information of a given node may include, for example, a node ID of the given node; a match count between hash values of data on primary source node 102 and hash values of data on the given node; and a list of matched hash values between primary source node 102 and the given node. Each cluster management system may perform such comparison for each node of a cluster under its management. For example, referring to FIG. 1, cluster management system 112 may perform such comparison for nodes 120, 122, and 124 in cluster 106; cluster management system 114 may perform such comparison for nodes 130, 132, and 134 in cluster 108; and cluster management system 116 may perform such comparison for nodes 140, 142, and 144 in cluster 110.

Each cluster management system (e.g., 112, 114, and 116) may organize mapping information of nodes present in their respective cluster (e.g., 106, 108, and 110). In an example, mapping information of nodes in a cluster may be organized in a tabular form. Each cluster management system (e.g., 112, 114, and 116) may generate a table that captures mapping information of nodes present in their respective cluster. For example, referring to FIG. 1, cluster management system 112 may generate a table 170 that captures mapping information of nodes present in cluster 106. As described above, mapping information of a given node may include, for example, a node ID 180 of the given node; a match count 182 between hash values of data on primary source node 102 and hash values of data on the given node; and a list 184 of matched hash values between primary source node 102 and the given node. Likewise, cluster management system 114 may generate a table 172 that captures mapping information of nodes present in cluster 108. And, cluster management system 116 may generate a table 174 that captures mapping information of nodes present in cluster 110. Each cluster management system may share mapping information of nodes present in their respective cluster with primary source node 102. The mapping information may be shared, for example, in a tabular form.

In response to receiving mapping information of nodes in a respective cluster (for example, 106, 108, and 110) from a corresponding cluster management system (112, 114, and 116, respectively), primary source node 102 may through instructions 166 identify a backup cluster for backing up data on primary source node 102. In an example, the identification may include generating, by primary source node 102, a ranking of nodes within each individual cluster, based on mapping information of nodes received from respective cluster management system. In an example, the mapping information may be used by primary source node 102 to generate a ranking of nodes across all clusters. As mentioned earlier, the mapping information of a given node may include a match count between hash values of data on primary source node 102 and hash values of data on the given node. Based on the match count information, a ranking of nodes may be generated for a given cluster and/or across all clusters.

For example, referring to FIG. 1, based on the match count information, a ranking of nodes for each of the clusters 106, 108, and 110 may be generated. Thus, for cluster 106, nodes present therein may be ranked in the following order N2 (6), N1 (5), and N3 (4), based on the match count information (indicated alongside in parenthesis). Likewise, for cluster 108, nodes present therein may be ranked in the following order N4 (9), N5 (7), and N6 (2). And, for cluster 110, the ranking of nodes may be as follows: N9 (7), N8 (5), and N7 (2). In an example, mapping information may be used by primary source node 102 to generate a ranking of nodes across all clusters. Thus, referring to the example in FIG. 1, nodes across clusters 106, 108, and 110 may be ranked as follows: N4, N5, N6, N9, N8, N7, N2, N1, and N3. In an example, the ranking may be presented in a tabular form 190.

Based on a ranking of nodes across all clusters, primary source node 102 may identify the first-ranked node as primary destination node. The primary destination node may provide a highest match count between hash values of data on primary source node 102 and hash values of data on the destination node. Thus, referring to the example in FIG. 1, primary source node may identify the first-ranked node N4 as primary destination node.

In an example, primary source node 102 may recommend the cluster that includes the first-ranked node as backup cluster for data backup. Thus, referring to the example in FIG. 1, primary source node may recommend cluster 108 that includes the first-ranked node N4 for data backup 192. In an example, the backup cluster and/or primary destination node may be used for backing up data on primary source node 102. In an example, primary source node 102 may initiate a backup of data on primary source node 102 to the primary destination node.

In an example, based on a ranking of nodes across all clusters, primary source node 102 may identify the second-ranked node as secondary destination node. The second-ranked node may provide a second highest match count between hash values of data on primary source node 102 and hash values of data on the destination node, after the primary destination node. Referring to the example in FIG. 1, primary source node may identify the second-ranked node N5 as secondary destination node. In an example, primary source node may recommend the cluster that includes the second-ranked node as secondary backup cluster. Referring to the example in FIG. 1, primary source node may recommend cluster 108 that includes the second-ranked node N5 for data backup 192. In an example, the secondary destination node may be used for backing up data on the primary source node 102. In an example, primary source node 102 may initiate a backup of data from primary source node 102 to the secondary destination node.

In an example, primary source node 102 may recommend the backup cluster and/or primary destination node for backing up data on the primary source node 102 to a user. In response to a user input, primary source node 102 may initiate back up of data on primary source node 102 to the primary destination node in the backup cluster.

In an example, to initiate back up of data from primary source node 102 to the primary destination node in the backup cluster, primary source node 102 may send a ranking of nodes generated for the backup cluster to the corresponding cluster management system that manages the backup cluster. In response, the cluster management system may orchestrate backing up of data from the primary source node 102 to a primary destination node in the backup cluster. The primary destination node provides a highest match count between the hash values of data on the primary source node 102 and hash values of data on the primary destination node.

In an example, the orchestration may comprise identifying, by cluster management system of the backup cluster, hash values of data on primary source node 102 that are absent on the primary destination node. These hash values of data may be identified as a first set of hash values. Cluster management system of the backup cluster may then obtain data corresponding to the first set of hash values from a node “closer” (i.e. in same subnet) to the primary destination node, relative to the primary source node 102.

Cluster management system of the backup cluster may further identify hash values of data on primary source node 102 that are absent both on the primary destination node and the node closer (i.e. in same subnet) to the primary destination node. These hash values of data may be identified as a second set of hash values. Cluster management system of the backup cluster may divide the second set of hash values into two halves. Cluster management system of the backup cluster may obtain data corresponding to a half of the divided hash values from primary source node 102. The data corresponding to the other remaining half of the divided hash values may be obtained from a replica node 104 of the primary source node 102. Obtaining data in this manner brings efficiency in the underlying network since it leads to a reduction in network traffic and backup/restore time.

In an example, primary source node 102 may recommend the secondary backup cluster and/or secondary destination node for backing up data on primary source node 102 to a user. In response to a user input, primary source node 102 may initiate back up of data from primary source node data 102 to the secondary destination node.

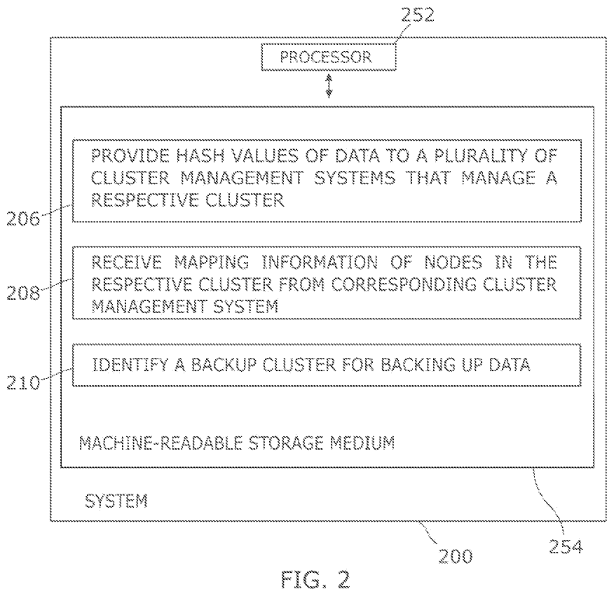

FIG. 2 illustrates an example system 200 for identifying a backup cluster for data backup. In an example, system 200 may be similar to primary source node 102 of FIG. 1, in which like reference numerals correspond to the same or similar, though perhaps not identical, components. For the sake of brevity, components or reference numerals of FIG. 2 having a same or similarly described function in FIG. 1 are not being described in connection with FIG. 2. Accordingly, components of system 200 that are similarly named and illustrated in reference to FIG. 1 may be considered similar.

In an example, system 200 may include any type of computing device capable of reading machine-executable instructions. Examples of the computing device may include, without limitation, a server, a desktop computer, a notebook computer, a tablet computer, and the like. In an example, system 200 may be a storage node, with a processing capacity.

In an example, system may include a processor 252 and a machine-readable storage medium 254 communicatively coupled through a system bus. Processor 252 may be any type of Central Processing Unit (CPU), microprocessor, or processing logic that interprets and executes machine-readable instructions stored in machine-readable storage medium 254. Machine-readable storage medium 254 may be a random access memory (RAM) or another type of dynamic storage device that may store information and machine-readable instructions that may be executed by processor 252. For example, machine-readable storage medium 254 may be Synchronous DRAM (SDRAM), Double Data Rate (DDR), Rambus DRAM (RDRAM), Rambus RAM, etc. or storage memory media such as a floppy disk, a hard disk, a CD-ROM, a DVD, a pen drive, and the like. In an example, machine-readable storage medium 254 may be a non-transitory machine-readable medium.

In an example, machine-readable storage medium 254 may store machine-readable instructions (i.e. program code) 206, 208, and 210 that, when executed by processor 252, may at least partially implement some or all functions of primary source node.

In an example, system 200 may include instructions 206 to provide hash values of data on the system to a plurality of cluster management systems (for example, 112, 114, and 116 of FIG. 1). As described above, each cluster management system may manage a respective cluster. Instructions 208 may be executed by processor 252 to receive mapping information of nodes in the respective cluster from corresponding cluster management system. As described above, the mapping information of a given node may indicate an extent of a match between the hash values of data on the system and hash values of data on the given node. Instructions 210 may be executed by processor 252 to identify, based on mapping information of nodes in the respective cluster, a backup cluster for backing up data present on system 200, as described above.

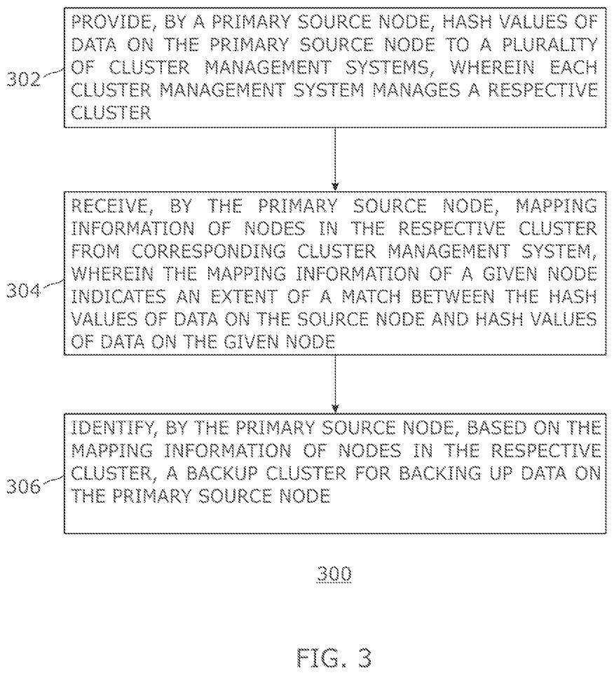

FIG. 3 illustrates an example method 300 of identifying a backup cluster for data backup. The method 300, which is described below, may be executed on a system such as primary source node 102 of FIG. 1 or system 200 of FIG. 2. However, other computing platforms may be used as well.

At block 302, a primary source node may provide hash values of data on the primary source node to a plurality of cluster management systems, as described above, wherein each cluster management system may manage a respective cluster. In response, at block 304, the primary source node may receive mapping information of nodes in the respective cluster from corresponding cluster management system, as described above. The mapping information of a given node may indicate an extent of a match between the hash values of data on the primary source node and hash values of data on the given node. At block 306, based on mapping information of nodes, the primary source node may identify a backup cluster for backing up data present on the primary source node, as described above. In an example, identifying a backup cluster may include identifying a primary destination node in the backup cluster for backing up data present on the primary source node, as described above.

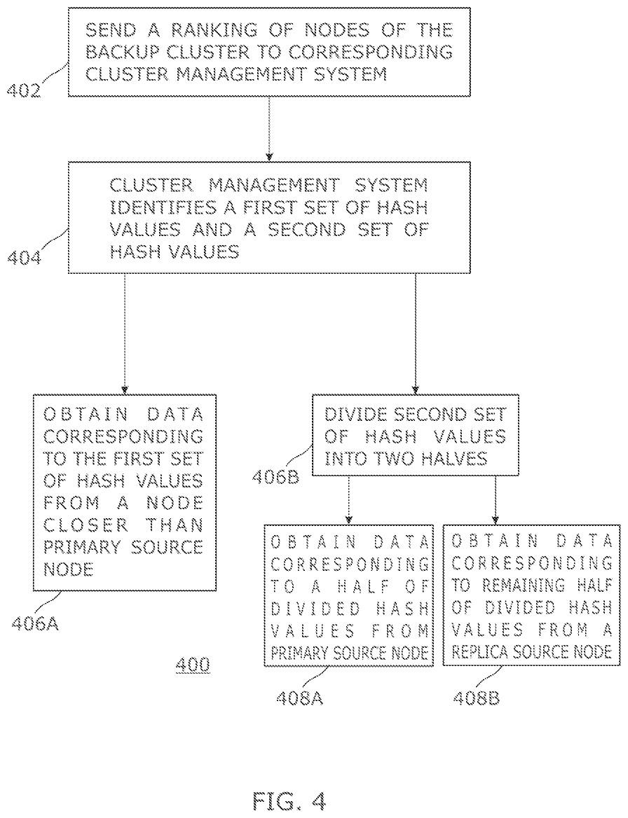

Referring to FIG. 4, at block 402, to initiate back up of data from the primary source node to a primary destination node in the backup cluster, the primary source node may send a ranking of nodes in the backup cluster to a corresponding cluster management system. In response, the cluster management system may orchestrate backing up of data of the primary source node to the primary destination node.

At block 404, orchestration by the cluster management system of the backup cluster may comprise identifying hash values of data on the primary source node that are absent on the primary destination node. These hash values of data may be identified as a first set of hash values. At block 406 A, the cluster management system of the backup cluster may obtain data corresponding to the first set of hash values from a node closer (i.e. same subnet) to the primary destination node, relative to the primary source node, as described above.

Also, at block 404, the cluster management system of the backup cluster may identify hash values of data on the primary source node that are absent both on the primary destination node and the node closer (i.e. same subnet) to the primary destination node, as described above. These hash values of data may be identified as a second set of hash values. At block 406 B, the cluster management system of the backup cluster may divide the second set of hash values into two halves. At block 408 A, the cluster management system of the backup cluster may obtain data corresponding to a half of the divided hash values from the primary source node, as described above. At block 408 B, data corresponding to the remaining half of hash values may be obtained from a replica source node (e.g., 104) of the primary source node, as described above.

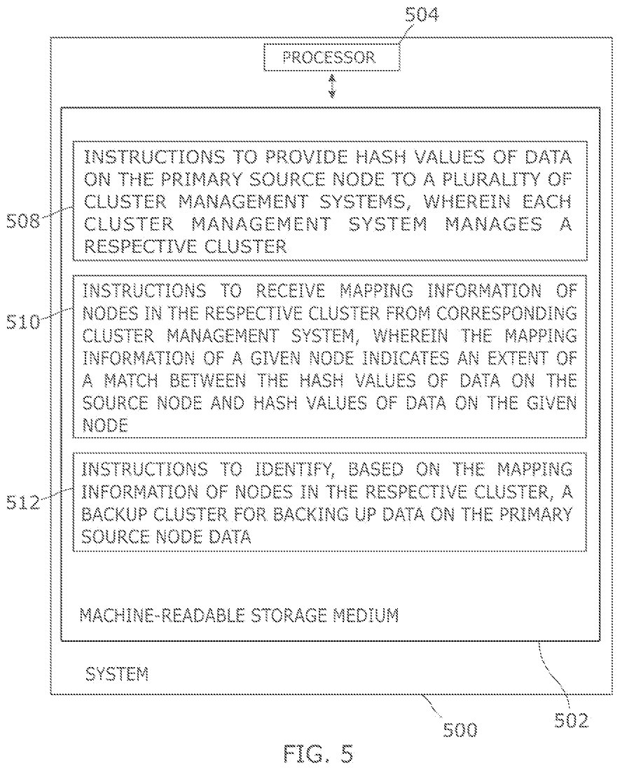

FIG. 5 is a block diagram of an example system 500 including instructions in a machine-readable storage medium for identifying a backup cluster for data backup. System 500 includes a processor 502 and a machine-readable storage medium 504 communicatively coupled through a system bus. In an example, system 500 may be analogous to primary source node 102 of FIG. 1 or system 200 of FIG. 2. Processor 502 may be any type of Central Processing Unit (CPU), microprocessor, or processing logic that interprets and executes machine-readable instructions stored in machine-readable storage medium 504. Machine-readable storage medium 504 may be a random access memory (RAM) or another type of dynamic storage device that may store information and machine-readable instructions that may be executed by processor 502. For example, machine-readable storage medium 504 may be Synchronous DRAM (SDRAM), Double Data Rate (DDR), Rambus DRAM (RDRAM), Rambus RAM, etc. or storage memory media such as a floppy disk, a hard disk, a CD-ROM, a DVD, a pen drive, and the like.

In an example, machine-readable storage medium 504 may be a non-transitory machine-readable medium. Machine-readable storage medium 504 may store instructions 506, 508, and 510. In an example, instructions 506 may be executed by processor 502 of a primary source node to provide hash values of data on the primary source node to a plurality of cluster management systems, as described above, wherein each cluster management system may manage a respective cluster. Instructions 508 may be executed by processor 502 to receive, by the primary source node, mapping information of nodes in the respective cluster from corresponding cluster management system, wherein the mapping information of a given node indicates an extent of a match between the hash values of data on the source node and hash values of data on the given node, as described above. Instructions 510 may be executed by processor 502 to identify, by the primary source node, based on the mapping information of nodes in the respective cluster, a backup cluster for backing up data on the primary source node data, as described above. In an example, the instructions to identify may include instructions to generate, based on the mapping information of nodes in the respective cluster, a ranking of nodes within the respective cluster, as described above.

In an example, machine-readable storage medium 504 may further store instructions that, when executed by processor 502 of the primary source node may identify the backup cluster for restoring data to the primary source node, as described above. In an example, machine-readable storage medium 504 may further store instructions that, when executed by processor 502 of the primary source node may recommend the backup cluster for backing up data on the primary source node data to a user, as described above. In an example, machine-readable storage medium 504 may further store instructions that, when executed by processor 502 of the primary source node may initiate back up of data on the primary source node data to a node of the backup cluster in response to a user input, as described above.

For the purpose of simplicity of explanation, the example methods of FIGS. 3 and 4 are shown as executing serially, however it is to be understood and appreciated that the present and other examples are not limited by the illustrated order. The example systems of FIGS. 1, 2, and 5, and methods of FIGS. 3 and 4 may be implemented in the form of a computer program product including computer-executable instructions, such as program code, which may be run on any suitable computing device in conjunction with a suitable operating system (for example, Microsoft Windows®, Linux®, UNIX®, and the like). Examples within the scope of the present solution may also include program products comprising non-transitory computer-readable media for carrying or having computer-executable instructions or data structures stored thereon. Such computer-readable media can be any available media that can be accessed by a general purpose or special purpose computer. By way of example, such computer-readable media can comprise RAM, ROM, EPROM, EEPROM, CD-ROM, magnetic disk storage or other storage devices, or any other medium which can be used to carry or store desired program code in the form of computer-executable instructions and which can be accessed by a general purpose or special purpose computer. The computer readable instructions can also be accessed from memory and executed by a processor.

It may be noted that the above-described examples of the present solution is for the purpose of illustration only. Although the solution has been described in conjunction with a specific example thereof, numerous modifications may be possible without materially departing from the teachings and advantages of the subject matter described herein. Other substitutions, modifications and changes may be made without departing from the spirit of the present solution.

I/We claim:

1. A system comprising:
a processor; and
a machine-readable medium storing instructions that, when executed by the processor, cause the processor to:
provide hash values of data on the system to a plurality of cluster management systems, wherein each cluster management system manages a respective cluster;
receive mapping information of nodes in the respective cluster from corresponding cluster management system, wherein the mapping information of a given node indicates an extent of a match between the hash values of data on the system and hash values of data on the given node; and
identify, based on the mapping information of nodes in the respective cluster, a backup cluster for backing up data on the system.

2. The system of claim 1, wherein the machine readable medium stores instructions that, when executed, cause the processor to generate, based on the mapping information of nodes in the respective cluster, a ranking of nodes across all clusters.

3. The system of claim 2, wherein the machine readable medium stores instructions that, when executed, cause the processor to identify, based on the ranking of nodes across all clusters, a primary destination node for backing up data on the system.

4. The system of claim 3, wherein the machine readable medium stores instructions that, when executed, cause the processor to initiate a backup of data on the system to the primary destination node.

5. The system of claim 2, wherein the machine readable medium stores instructions that, when executed, cause the processor to identify, based on the ranking of nodes across all clusters, a secondary destination node for backing up data on the system.

6. The system of claim 5, wherein the machine readable medium stores instructions that, when executed, cause the processor to initiate a backup of data on the system to the secondary destination node.

7. The system of claim 1, wherein the mapping information of the given node includes a node ID of the given node, a match count between the hash values of data on the system and the hash values of data on the given node, and a list of matched hash values between the system and the given node.

8. The system of claim 1, wherein the machine readable medium stores instructions that, when executed, cause the processor to initiate a backup of data on the system to the backup cluster.

9. The system of claim 1, wherein the machine readable medium stores instructions that, when executed, cause the processor to initiate a backup of the system to a node in the backup cluster.

10. A method comprising:
providing, by a primary source node, hash values of data on the primary source node to a plurality of cluster management systems, wherein each cluster management system manages a respective cluster;
receiving, by the primary source node, mapping information of nodes in the respective cluster from corresponding cluster management system, wherein the mapping information of a given node indicates an extent of a match between the hash values of data on the source node and hash values of data on the given node; and
identifying, by the primary source node, based on the mapping information of nodes in the respective cluster, a backup cluster for backing up data on the primary source node.

11. The method of claim 10, further comprising sending the mapping information of nodes in the respective cluster to cluster management system that manages the backup cluster, wherein, in response, the cluster management system orchestrates backing up of data on the system to a primary destination node in the backup cluster.

12. The method of claim 11, wherein orchestration includes:
identifying hash values of data on the primary source node that are absent on the primary destination node as a first set of hash values; and
obtaining data corresponding to the first set of hash values from a node closer to the primary destination node, relative to the primary source node.

13. The method of claim 12, further comprising:
identifying hash values of data on the primary source node that are absent both on the primary destination node and the node closer to the primary destination node as a second set of hash values;
dividing the second set of hash values into two halves;
obtaining data corresponding to a half of the divided hash values from the primary source node; and
obtaining data corresponding to other remaining half of the divided hash values from a replica node of the primary source node.

14. The method of claim 11, wherein the primary destination node provides a highest match count between the hash values of data on the system and hash values of data on the destination node.

15. The method of claim 11, wherein the hash values of data include hash values of data of a virtual machine (VM) on the primary source node.

16. A non-transitory machine-readable storage medium comprising instructions, the instructions executable by a processor of a primary source node to:
provide hash values of data on the primary source node to a plurality of cluster management systems, wherein each cluster management system manages a respective cluster;
receive mapping information of nodes in the respective cluster from corresponding cluster management system, wherein the mapping information of a given node indicates an extent of a match between the hash values of data on the source node and hash values of data on the given node; and
identify, based on the mapping information of nodes in the respective cluster, a backup cluster for backing up data on the primary source node data.

17. The storage medium of claim 16, further comprising instructions to identify the backup cluster for restoring data to the primary source node.

18. The storage medium of claim 16, wherein the instructions to identify include instructions to generate, based on the mapping information of nodes in the respective cluster, a ranking of nodes within the respective cluster.

19. The storage medium of claim 16, further comprising instructions to recommend the backup cluster for backing up data on the primary source node data to a user.

20. The storage medium of claim 16, further comprising instructions to initiate back up of data on the primary source node data to a node of the backup cluster in response to a user input.
